(19) United States
(12) Patent Application Publication
(10) Pub. No.: US 2025/0244641 A1
(43) Pub. Date: Jul. 31, 2025

(54) Electronic Devices Having Adjustable Indicator Lights

(71) Applicant: Apple Inc., Cupertino, CA (US)

(72) Inventors: Dong Zheng, Los Altos, CA (US); Kenneth J. Vampola, Los Altos, CA (US)

(21) Appl. No.: 18/952,782

(22) Filed: Nov. 19, 2024

Related U.S. Application Data
(60) Provisional application No. 63/626,891, filed on Jan. 30, 2024.

(51) Int. Cl. G03B 17/18; G01J 1/42; H05B 45/12; H05B 47/11

(52) U.S. Cl. CPC G03B 17/18; G01J 1/4204; H05B 45/12; H05B 47/11

(57) ABSTRACT

An electronic device may include one or more input-output devices, such as a camera and/or a microphone, and an indicator light that is activated to indicate that the camera/microphone is on. The indicator light may be formed in an indicator light module that includes a light source and an associated ambient light sensor. The light source may emit light, and the brightness of the emitted light may be adjusted based on measurements from the ambient light sensor. The light source and the associated ambient light sensor may be formed within an integrated package and/or the light source and the associated ambient light sensor may be formed from a common light-emitting diode. The ambient light sensor may be used to verify whether the light source is active. Alternatively or additionally, a voltage sensor may be used to verify whether the light source is active.

This application claims the benefit of U.S. provisional patent application No. 63/626,891, filed Jan. 30, 2024, which is hereby incorporated by reference herein in its entirety.

### FIELD

This relates generally to electronic devices, and, more particularly, to electronic devices with lights.

### BACKGROUND

Electronic devices such as laptop computers, cellular telephones, and other equipment are sometimes provided with lights, such as indicator lights.

### SUMMARY

An electronic device may have a display with an array of pixels forming an active display area. The electronic device may also include one or more input-output devices, such as a camera and/or a microphone. During operation of the device, the array of pixels may be used to display an image for the user. In an inactive border area or other inactive display area that is free of pixels, an opaque masking layer may be included in the display to block internal device components from view from the exterior of the electronic device. Ambient light may pass through an opening in the opaque masking layer.

The electronic device may have an indicator light that is activated to indicate that the camera/microphone is on. The indicator light may be formed in an indicator light module is aligned with the opening in the opaque masking layer. The indicator light module may include a light source and an associated ambient light sensor.

The light source may emit light, and the brightness of the emitted light may be adjusted based on measurements from the ambient light sensor. The light source and the associated ambient light sensor may be formed within an integrated package and/or the light source and the associated ambient light sensor may be formed from a common light-emitting diode.

The indicator light module may not be connected to control circuitry or other circuitry within the electronic device, and the ambient light sensor may be used to verify whether the light source is active. Alternatively or additionally, a voltage sensor may be used to verify whether the light source is active.

### BRIEF DESCRIPTION OF THE DRAWINGS

FIG. 1 is a schematic diagram of an illustrative electronic device having an ambient light sensor module in accordance with some embodiments.

FIGS. 2-4 are perspective views of illustrative electronic devices in accordance with some embodiments.

FIG. 5 is a side view of an illustrative indicator light module under a clear aperture in an opaque masking layer in accordance with embodiments.

FIG. 6 is a schematic diagram of an illustrative indicator light module that includes a light source and an ambient light sensor in accordance with some embodiments.

FIG. 7 is an illustrative timing diagram of a light source and an associated ambient light sensor in accordance with some embodiments.

FIG. 8 is a side view of an illustrative indicator light module that includes a light source and an ambient light sensor in accordance with some embodiments.

FIG. 9 is a schematic diagram of an illustrative indicator light module that includes a light-emitting diode that emits light and senses ambient light in accordance with some embodiments.

FIG. 10 is a schematic diagram of an illustrative indicator light module that includes a light-emitting diode and a sensor that measures the current, voltage, and/or temperature of the light-emitting diode in accordance with some embodiments.

### DETAILED DESCRIPTION

Electronic devices, such as cellular telephones, computers (e.g., laptop computers), tablets, smart speakers, device accessory cases, charging cables, and wearable devices (e.g., wristwatch devices or head-mounted devices), may include one or more indicator lights. For example, the indicator lights may form a privacy indicator, which may be activated when one or more components, such as cameras and/or microphones, in the electronic devices are activated. In this way, users of the electronic devices may be alerted when one or more of these components is active.

The brightness of the indicator lights may be adjusted based on the brightness of ambient light in the environment of the electronic device. To determine the brightness of ambient light, the electronic device may include one or more optical sensors, such as ambient light sensors. The ambient light sensors may produce signals in response to ambient light, thereby indicating the ambient brightness of a device's surroundings. In response to the ambient brightness, the brightness of the indicator lights may be adjusted.

These adjustments to the indicator lights based on the ambient brightness may be controlled locally. In other words, the adjustments may be made without any intervention from other components internal or external to the electronic device, including control circuitry, firmware, or other components. To make the indicator light adjustments locally, an ambient light sensor may be co-located with, or located near, the indicator light. In some embodiments, for example, the indicator light and the ambient light sensor may be formed in an integrated indicator light module. Alternatively, the indicator light may be formed from a light-emitting diode (LED) that may be used to form the indicator light and to sense the ambient light brightness.

In other embodiments, the indicator light may be formed separately from the ambient light sensor. To ensure that the indicator light is properly activated, a separate sensor may be used to measure the indicator light drive current, voltage, and/or temperature. In this way, the indicator light may be adjusted by control circuitry, but the control circuitry may verify that the indicator light is functioning properly.

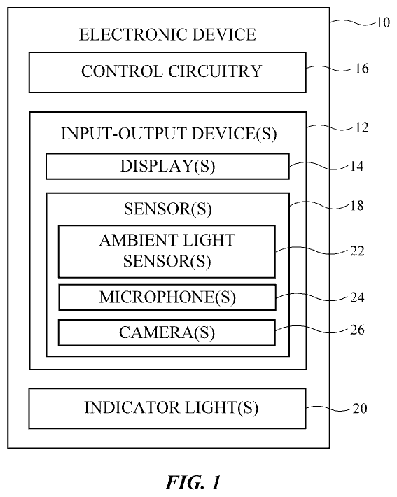

An illustrative electronic device of the type that may be provided with one or more indicator lights is shown in FIG. 1. Electronic device 10 of FIG. 1 may be a computing device such as a laptop computer, a computer monitor containing an embedded computer, a tablet computer, a cellular telephone, a media player, or other handheld or portable electronic device, a smaller device such as a wristwatch or other device worn on a user's wrist, a pendant device, a headphone or earpiece device, a device embedded in eyeglasses or other equipment worn on a user's head, or other wearable or miniature device, a television, a computer display that does not contain an embedded computer, a gaming device, a charging cable, a case for an electronic device, a navigation device, an embedded system such as a system in which electronic equipment with a display is mounted in a kiosk or automobile, equipment that implements the functionality of two or more of these devices, or other electronic equipment.

As shown in FIG. 1, electronic device 10 may have control circuitry 16. Control circuitry 16 may include storage and processing circuitry for supporting the operation of device 10. The storage and processing circuitry may include storage such as hard disk drive storage, nonvolatile memory (e.g., flash memory or other electrically-programmable-read-only memory configured to form a solid-state drive), volatile memory (e.g., static or dynamic random-access-memory), etc. Processing circuitry in control circuitry 16 may be used to control the operation of device 10. The processing circuitry may be based on one or more microprocessors, microcontrollers, digital signal processors, baseband processors, power management units, audio chips, application specific integrated circuits, etc. Control circuitry 16 may include communications circuitry for supporting wired and/or wireless communications between device 10 and external equipment. For example, control circuitry 16 may include wireless communications circuitry such as cellular telephone communications circuitry and wireless local area network communications circuitry.

Input-output devices in device 10 such as input-output devices 12 may be used to allow data to be supplied to device 10 and to allow data to be provided from device 10 to external devices. Input-output devices 12 may include buttons, joysticks, scrolling wheels, touch pads, key pads, keyboards, microphones, speakers, tone generators, vibrators, cameras, light-emitting diodes and other status indicators, data ports, etc. A user can control the operation of device 10 by supplying commands through input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements.

Input-output devices 12 may also include one or more sensors such as sensor 18. Sensors 18 may include a capacitive sensor, a light-based proximity sensor, a magnetic sensor, an accelerometer, a force sensor, a touch sensor, a temperature sensor, a pressure sensor, a compass, a microphone, a radio-frequency sensor, a three-dimensional image sensor, a camera, a light-based position sensor (e.g., a lidar sensor), and other sensors. Sensors 18 may also include one or more ambient light sensors 22, which are light detectors that configured to detect ambient light. Ambient light sensors 22 may include one or more monochrome ambient light sensors and one or more color ambient light sensors that are configured to measure ambient light from the environment in which device 10 is operated. A monochrome ambient light sensor may be used to measure ambient light intensity. A color ambient light sensor may be used to measure the color (color spectrum, color temperature, color coordinates, etc.) of ambient light and may be used to measure ambient light intensity.

To make color measurements, a color ambient light sensor in device 10 may have a light detector such as a photodiode that is overlapped by a tunable wavelength filter and/or may have multiple channels each of which has a light detector such as a photodiode that is overlapped by a filter that passes a different color of light (e.g., a different wavelength band) to that light detector. Photodetectors such as photodiodes may be formed in a semiconductor die. By processing the readings from each of the multiple channels, the relative intensity of each of the different colors of light can be determined. Using data from the different channels in a color ambient light sensor, control circuitry 16 can therefore produce ambient light color temperature measurements and other color measurements (e.g., colors represented in color coordinates, etc.). The ambient light color information may be used in controlling display 14 and/or in taking other actions in device 10. As an example, the color cast of images displayed on display 14 can be adjusted based on ambient light color measurements (e.g., to make the images on display 14 yellower in warm ambient lighting conditions and to make the images on display 14 bluer in cold ambient lighting conditions). If desired, display brightness may be automatically increased by control circuitry 16 in response to detection of bright ambient light conditions and may be automatically decreased by control circuitry 16 in response to detection of dim ambient light conditions. Adjustments to the brightness of the image on display 14 in this way based on ambient light sensor measurements from an ambient light sensor in device 10 may help enhance user comfort when viewing images.

Electronic device 10 may include one or more ambient light sensors 22. Illustrative arrangements in which device 10 includes a single ambient light sensor 22 are sometimes described herein as an example. In some configurations, ambient light sensor 22 may be located directly under or nearly under display 14 (e.g., under an active display area or under an inactive border of a display, in an inactive notch formed along an edge of an active display area, in an inactive island that forms a window area within an active display area, etc.). Alternatively, ambient light sensor 22 may be located in an inactive area of display 14 (e.g., a peripheral area adjacent to display 14 that does not include any pixels) or on another portion of device 10.

Display 14 may be an organic light-emitting diode display, a liquid crystal display, microLED display, or other display. In some configurations, organic light-emitting diode pixel light emission or backlight unit light emission in a backlit liquid crystal display may be temporarily dimmed to help prevent backlight leakage that could generate stray light. This may help reduce noise during ambient light measurements. Ambient light measurements can also be gathered while a display backlight is active. To help reduce crosstalk while a backlight is active, an ambient light sensor module may be provided with a light attenuator. The light attenuator may attenuate stray light to help reduce stray light noise. The light attenuator may also help provide the ambient light sensor module with a dark outward appearance that matches surrounding opaque masking material that is used in the inactive area of the display. A clear aperture may be formed in an opaque masking layer to allow ambient light to reach the ambient light sensor module.

Sensors 18 may also include one or microphones 24 and/or one or more cameras 26. Control circuitry 16 may adjust microphones 24 and cameras 26, such as turning microphones 24 and cameras 26 on and off. To alert a user of device 10 that microphone 24, camera 26, and/or other sensor 18 is active (e.g., taking measurements in the environment of device 10), input-output devices 12 may include one or more indicator lights 20. For example, indicator light 20 may be activated and emit light when selected sensor(s) 18 are on, while indicator light 20 may be deactivated and not emit light when the selected sensor(s) 18 are off. In some embodiments, the brightness of indicator light 20 may be adjusted based on the brightness of ambient light measured by ambient light sensor 22.

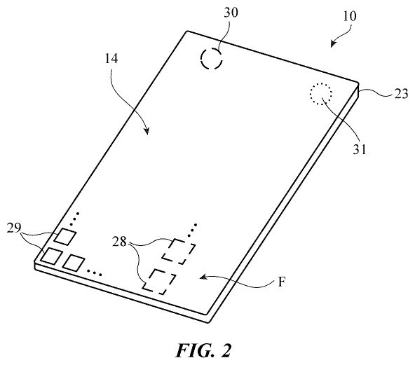

A perspective view of an illustrative electronic device of the type that may include an indicator light is shown in FIG. 2. In the example of FIG. 2, device 10 includes a display such as display 14 mounted in housing 23. Display 14 may be a liquid crystal display, a light-emitting diode display such as an organic light-emitting diode display or a display formed from crystalline semiconductor light-emitting diode dies, or other suitable display. Display 14 may have an array of pixels 29 extending across some or all of front face F of device 10 and/or other external device surfaces. The pixel array may be rectangular or may have other suitable shapes. Display 14 may be protected using a display cover layer (e.g., a transparent front housing layer) such as a layer of transparent glass, clear plastic, sapphire, or other clear layer. The display cover layer may overlap the array of pixels 29.

Housing 23, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 23 and display 14 may separate an interior region of device 10 from an exterior region surrounding device 10. Housing 23 may be formed using a unibody configuration in which some or all of housing 23 is machined or molded as a single structure or may be formed using multiple structures (e.g., an internal frame structure, one or more structures that form exterior housing surfaces, etc.). If desired, a wristband or other strap may be coupled to a main portion of housing 23 (e.g., in configurations in which device 10 is a wristwatch). Internal electrical components 28 (e.g., integrated circuits, discrete components, etc.) for forming control circuitry 16 and input-output devices 12 may be mounted in the interior of housing 23. In some configurations, components 28 may be attached to display 14 (e.g., display driver circuitry may be mounted to the inner surface of display 14).

Pixels 29 may cover all of the front face F of device 10 or display 14 may have inactive areas (e.g., notches, rectangular islands, or other regions) that are free of pixels 29. The inactive areas may be used to accommodate an opening for a speaker and windows for optical components such as an indicator light, image sensors, an ambient light sensor, an optical proximity sensor, a three-dimensional image sensor such as a structured light three-dimensional image sensor, a camera flash, etc.

An indicator light and/or an ambient light sensor may be formed under a window opening in housing 23 (e.g., a sensor may be mounted under a hole in a metal housing wall), may be formed under the active area of display 14, or may be formed under an inactive display area. For example, an indicator light and/or an ambient light sensor may be formed on front face F along one of the edges of device 10 such as illustrative region 30 of FIG. 2. The indicator light and an associated ambient light sensor (e.g., an ambient light sensor that takes measurements that are used to adjust the indicator light) may be co-located in the same region (e.g., region 30). Alternatively, the indicator light and the associated ambient light sensor may be formed in separate regions. For example, the indicator light may be formed in region 30, and the ambient light sensor may be formed in region 31. Although regions 30 and 31 are both shown on front face F, this is merely illustrative. Regions 30 and 31 may be formed on any suitable portion of device 10, and may be formed on the same surface or different surfaces.

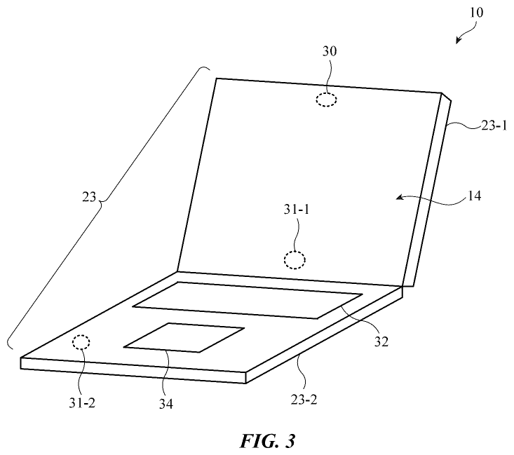

Device 10 of FIG. 2 may be a cellular telephone, tablet computer, wristwatch, or other portable device (as examples). If desired, an indicator light and an associated ambient light sensor may be provided in other electronic equipment. In the example of FIG. 3, device 10 is a laptop computer. Housing 23 of device 10 of FIG. 3 includes upper housing portion 23-1 and lower housing portion 23-2, which are joined by a hinge to allow these portions to rotate with respect to each other. Display 14 may be mounted in upper housing portion 23-1. Keyboard 32 and trackpad 34 may be mounted in lower housing portion 23-2. One or more indicator lights and one or more ambient light sensors may be mounted on housing 23 facing the exterior of device 10. As an example, an indicator light and an ambient light sensor module may be mounted under an active area of display 14 that is configured to display an image or an inactive area of display 14 (see, e.g., illustrative region 30). Alternatively, the indicator light and the associated ambient light sensor may be formed in separate regions. For example, the indicator light may be formed in region 30, and the ambient light sensor may be formed in region 31-1 in upper housing portion 23-1 or may be formed in region 31-2 in lower housing portion 23-2. The locations of regions 30, 31-1, and 31-2 in FIG. 3 are merely illustrative. Regions 30, 31-1, and/or 31-2 may be formed on any suitable portion of device 10, and may be formed on the same surface or different surfaces.

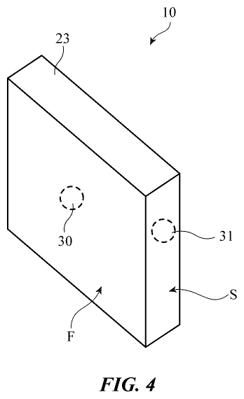

In some embodiments, an indicator light and an associated ambient light sensor may be incorporated into a device that does not include a display, such as a charging case for an electronic device, a charging cable, or other device. An illustrative example is shown in FIG. 4.

As shown in FIG. 4, device 10 may include region 30 on front face F of housing 23 and/or region 31 on sidewall S of housing 23. An indicator light and/or an associated ambient light sensor may be incorporated into device 10 in region 30. Alternatively, the indicator light and the associated ambient light sensor may be formed in separate regions. For example, the indicator light may be formed in region 30, and the ambient light sensor may be formed in region 31. Although region 30 is shown on front face F, and region 31 is shown in sidewall S, this is merely illustrative. Regions 30 and 31 may be formed on any suitable portion of device 10, and may be formed on the same surface or different surfaces.

Regardless of where the indicator light and associated ambient light sensor are formed on an electronic device, it may be desirable to help hide internal components of the device from view. For example, to help hide internal components in the interior of housing 23 from view, the inactive area of display 14 (FIGS. 1-3) may be provided with an opaque masking layer. The opaque masking layer may be any suitable color (e.g., black, gray, white, a non-neutral color such as blue, etc.). In an illustrative example, display 14 has an inactive area with an opaque masking layer formed from black ink. Other opaque materials may be used, if desired.

To permit light from the indicator light to exit device 10 and/or the associated ambient light sensor to receive ambient light in region 30, an opening (e.g., a clear aperture, sometimes referred to as a window or an opening) may be formed in the opaque masking layer in region 30. The shape of region 30 (e.g., the outline of the opaque masking layer opening when viewed from the exterior of device 10) may be circular, rectangular, or may have other suitable shapes. The opening may be completely free of opaque masking material (e.g., the opening may be a circular hole, etc.), thereby allowing close to 100% of light to pass through the opening (e.g., at least 95% or other suitable amount of light). However, this is merely illustrative. In general, any suitable amount of light may pass through the opening, such as at least 30% of light, at least 50% of light, at least 60% of light, or at least 75% of light, as examples.

In the interior of device 10, an indicator light module, which may include a light source and an associated ambient light sensor, may be aligned with the window in the opaque masking layer. To enhance the uniform appearance of the inactive area of display 14 and prevent the window from being overly noticeable to a user of device 10, the indicator light module that is mounted under the opening may be provided with a light attenuator (e.g., a visible-light-absorbing structure with a light transmission of about 2-16%, at least 3%, 5-10%, 8%, at least 4%, at least 6%, less than 20%, less than 10%, or other suitable light transmission value). The dark appearance of the light attenuator in the indicator light module may help absorb ambient light and reduce ambient light reflections to make the indicator light module visually blend with adjacent portions of the opaque masking layer.

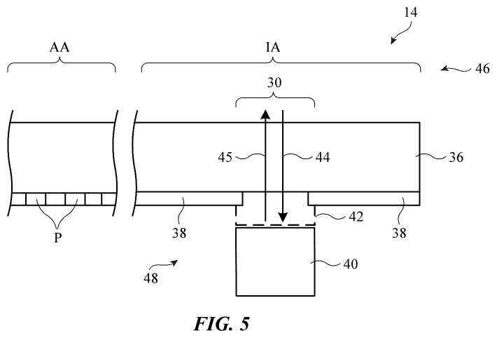

FIG. 5 is a side view of illustrative display with an indicator light module. Display 14 of FIG. 5 has an active area AA that displays images and an inactive area IA that is covered with opaque masking material and does not display images.

In the example of FIG. 5, display 14 has a transparent display cover layer such as display cover layer 36. Display cover layer 36 may be formed from glass, polymer, sapphire or other crystalline materials, and/or other transparent materials. In active area AA, display 14 has an array of pixels P for displaying an image. Pixels P may, for example, form a light-emitting diode display panel such as a thin-film organic light-emitting diode display panel or a display panel having a pixel array formed from crystalline semiconductor light-emitting diode dies (as examples). Configurations in which display 14 is a liquid crystal display may also be used. As shown in FIG. 5, in inactive area IA of display 14, pixels P are not present. Opaque masking layer 38 may be formed on the underside (inner surface) of display cover layer 36 in inactive area IA to hide internal components in interior region 48 from view from a user in the external environment (exterior region 46) surrounding device 10.

Indicator light module 40 may be mounted in alignment with an opening in opaque masking layer 38 in a window formed by region 30. This allows indicator light module 40 to emit light 45 and/or receive and measure ambient light 44 that passes through display cover layer 36 and the opening in layer 38 within the window formed by region 30. If desired, a layer of clear adhesive such as adhesive layer 42 may be used to attach indicator light module 40 to the interior of display cover layer 38 over the opening in layer 38. Other mounting arrangements may be used, if desired.

Although FIG. 5 shows indicator light module 40 in inactive area IA of display 14, this is merely illustrative. In some embodiments, indicator light module 40 may be in active area AA of display 14. Alternatively, indicator light module 40 may be formed in another region of device 10, such as on a sidewall or rear face of the housing of device 10.

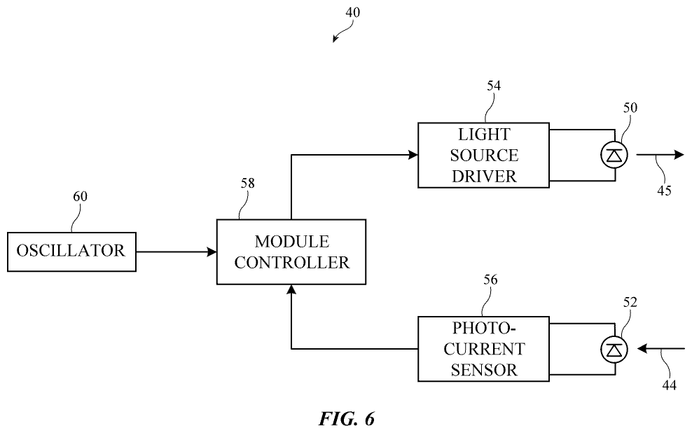

Regardless of where indicator light module 40 is included in an electronic device, it may be desirable to include a light source and an associated ambient light sensor within the indicator light module. An illustrative example of an indicator light module with a light source and an associated ambient light sensor is shown in FIG. 6

As shown in FIG. 6, indicator light module 40 may include light source 50 and ambient light sensor 52. Light source 50 may be a light-emitting diode (LED) or other suitable light source. Ambient light sensor 52 may be formed from a photodiode or other component to measure ambient light.

Light source 50 may be coupled to light source driver 54, and ambient light sensor 52 may be coupled to photocurrent sensor 56. Module controller 58 may be coupled to light source driver 54 and photocurrent sensor 56. Module controller 58 may in turn be coupled to oscillator 60. Module controller 58 may include storage and processing circuitry for supporting the operation of indicator light module 40. The storage and processing circuitry may include storage such as hard disk drive storage, nonvolatile memory (e.g., flash memory or other electrically-programmable-read-only memory configured to form a solid-state drive), volatile memory (e.g., static or dynamic random-access-memory), etc. Processing circuitry in module controller 58 may be used to control the operation of indicator light module 40. The processing circuitry may be based on one or more microprocessors, microcontrollers, digital signal processors, baseband processors, power management units, audio chips, application specific integrated circuits, etc. Oscillator 60 may be clock circuitry or other timing circuitry.

In operation, module controller 58 may receive clock signals from oscillator 60. Module controller 58 may also receive ambient light measurements from photocurrent sensor 56, which may generate the ambient light measurements based on current generated by ambient light sensor 52 in response to ambient light 44.

Based on the clock signals received from oscillator 60 and the ambient light measurements received from photocurrent sensor 56, module controller 58 may control light source driver 54. In particular, module controller 58 may send control signals to light source driver 54 to adjust light source 50. For example, light source driver 54 may turn on light source 50, turn off light source 50, and/or adjust the brightness of light source 50 based on the control signals from module controller 58.

When light source 50 is turned on, light source 50 may emit light 45. Light 45 may form an indicator to a user of electronic device 10 that a sensor, such as one of sensors 18 (FIG. 1) has been activated.

Module controller 58 may control the brightness of light source 50 based on the ambient light measurements received from photocurrent sensor 56. For example, in bright external conditions, the brightness of light source 50 may be increased, while in dim external conditions, the brightness of light source 50 may be decreased. In this way, the brightness of light source 50 may be adjusted based on the brightness of ambient light, and light 45 emitted by light source 50 may form an indicator light for a user of the device.

By co-locating ambient light sensor 52 and light source 50 in a single indicator light module 40, the brightness of light source 50 may be controlled locally (e.g., within module 40), without intervention from control circuitry outside of module 40, such as control circuitry 16 of FIG. 1. In other words, indicator light module 40 may be coupled directly to a sensor (e.g., a camera or microphone) and may turn on when the camera or microphone turns on. However, indicator light module 40 may not be connected to control circuitry or other components, and may not receive signals from the control circuitry or other components, within the electronic device.

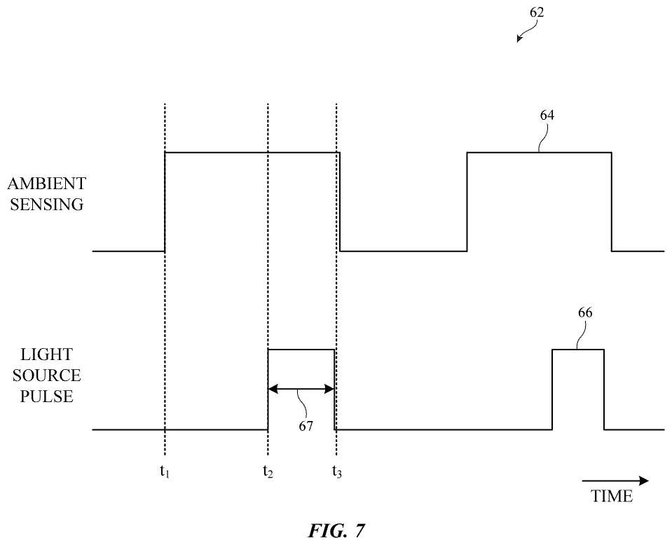

Because ambient light sensor 52 and light source 50 are both within indicator light module 40, ambient light sensor 52 may detect ambient light 44, as well as light that has been emitted by light source 50, if desired. For example, ambient light sensor 52 may be used to determine whether light source 50 is on. An illustrative timing diagram showing the operation of ambient light sensor 52 and light source 50 is shown in FIG. 7.

As shown in FIG. 7, timing diagram 62 may include curve 64 representing an illustrative timing of an ambient light sensor (e.g., ambient light sensor 52 of FIG. 6) and curve 66 representing an illustrative timing of a light source (e.g., light source 50 of FIG. 6).

Between time t₁ and t₂, the ambient light sensor may be turned on (e.g., may sense ambient light), while the light source may be turned off (e.g., may not be emitting light). Therefore, during time period t₁-t₂, the ambient light sensor measurements may indicate the brightness of the ambient, environmental light around the electronic device.

Between time t₂ and t₃, the ambient light sensor may be turned on (e.g., may sense ambient light) and the light source may also be turned on (e.g., may be emitting light). As a result, during time period t₂-t₃, the ambient light sensor measurements may indicate the brightness of the ambient, environmental light around the electronic device, as well as light that has been emitted by the light source that has been reflected to the ambient light sensor. As a result, by keeping the ambient light sensor on during time period t₂-t₃, the ambient light sensor may be used to verify that the light source has been turned on. However, leaving the ambient light sensor on during time period t₂ and t₃ is merely illustrative. If desired, the ambient light sensor may be left on during this time period to serve as a check that the light source is on. Alternatively, the light sensor may be turned off during this time period.

The ambient light sensor measurements taken during time period t₁-t₂ may be used to adjust the brightness of the light source (e.g., module controller 58 of FIG. 6 may adjust the light source brightness). For example, the module controller may adjust pulse width 67 of the light source, which in turn may adjust the brightness of the light source. In particular, by increasing pulse width 67, the brightness of the light source may be increased. By decreasing pulse width 67, the brightness of the light source may be decreased. In this way, the brightness of the light source may be adjusted based on ambient light measurements.

Although FIG. 7 shows the ambient light sensor turning off between t₃ and t₄, this is merely illustrative. If desired, the ambient light sensor may remain on the entire time that the light source is on (e.g., the ambient light sensor may measure ambient light continuously at and between light source pulses).

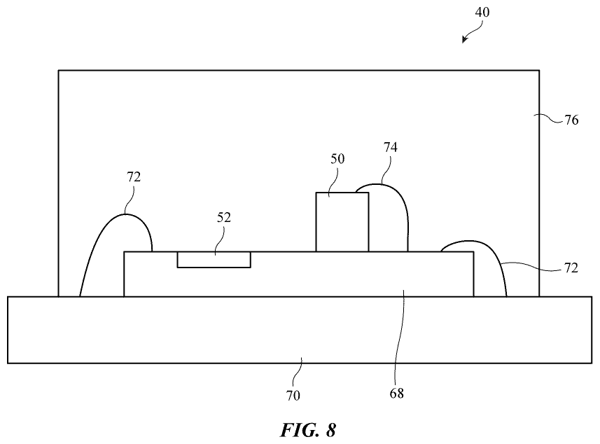

Regardless of the specific timing used to control an indicator light and an ambient light sensor, the indicator light and the ambient light sensor may be formed in an integrated indicator light module. An illustrative example of an integrated indicator light module that includes a light source and an ambient light sensor is shown in FIG. 8.

As shown in FIG. 8, indicator light module 40 may include light source 50 and ambient light sensor 52 on application-specific integrated circuit (ASIC) 68. ASIC 68 may include module controller 58, oscillator 60, light source driver 54, and photocurrent sensor 56 of FIG. 6 and/or any other suitable circuitry for the operation of indicator light module 40.

Ambient light sensor 52 may be an integrated photodiode that is a part of ASIC 68, while light source 50 may be mounted on ASIC 68 and coupled to ASIC 68 using wire bond 74 (or another suitable connection, such as a via structure). However, this is merely illustrative. If desired, ambient light sensor 52 may be formed from a photodiode that is mounted on ASIC 68 and/or light source 50 may be integrated into ASIC 68.

ASIC 68 may be mounted on printed circuit board (PCB) substrate 70. Additionally, ASIC 68 may be coupled to PCB substrate using wire bonds 72 (or other suitable connections, such as via structures).

By forming indicator light module 40 in this way, ambient light sensor 52 may be co-located with light source 50 in indicator light module 40, and measurements from ambient light sensor 52 may be used to adjust light source 50 and/or to verify whether light source 50 is on during a given period of time.

Cover layer 76, which may be formed from clear epoxy or other transparent material, may cover ambient light sensor 52, light source 50, and ASIC 68 and may be coupled to an upper surface of PCB substrate 70. However, cover layer 76 may be omitted, if desired.

In some embodiments, an on-chip OTP (one-time programming) may be included in indicator light module 40. The on-chip OTP may include calibration information, such as a calibration factor, for light source 50, as well as any other suitable information.

Although FIG. 8 shows light source 50 and ambient light sensor 52 formed on-chip (e.g., both light source 50 and ambient light sensor 52 are formed on ASIC 68), this is merely illustrative. In some embodiments, light source 50 and/or ambient light sensor 52 may be formed off-chip. Whether light source 50 and/or ambient light sensor 52 are formed on-chip or off-chip, ambient light measurements from ambient light sensor 52 may be used to adjust the brightness of light source 50 and/or to verify that light source 50 is on during a given time period.

Moreover, although FIG. 8 shows light source 50 and ambient light sensor 52 adjacent to one another on ASIC 68, this arrangement is merely illustrative. In some embodiments, light source 50 and ambient light sensor 52 may be stacked on top of one another. For example, light source 50 may be on top of ambient light sensor 52. However, ambient light sensor 52 may be formed on top of light source 50, if desired.

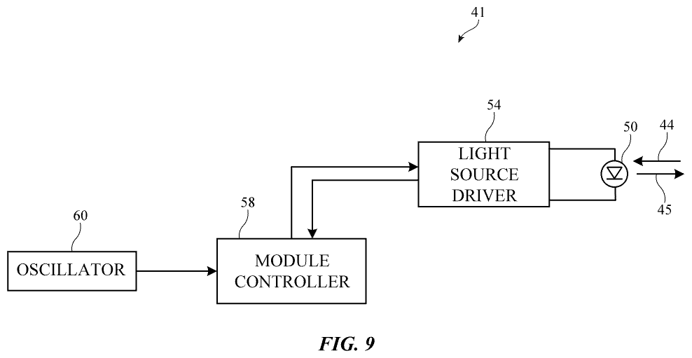

Although the examples of FIGS. 6-8 have shown and described indicator light module 40 that includes a light source and a separate ambient light sensor, this is merely illustrative. In some embodiments, an indicator light module may include a light-emitting diode that operates as a light source and as an ambient light sensor. An illustrative example is shown in FIG. 9.

As shown in FIG. 9, indicator light module 41 may include module controller 58 and oscillator 60, similar to indicator light module 40 of FIG. 6. However, light source 50 may be an LED that is used both for emitting light 45 and for sensing light 44. In particular, when light source 50 is not emitting light 45, light source driver 54 may reverse-bias light source 50 to use light source 50 as a photosensor, generating charge in response to ambient light 44, which may be converted to ambient light brightness measurements by light source driver 54. Module controller 58 may receive the ambient light brightness measurements and may adjust the brightness of light source 50 when emitting light 45 based on the ambient light brightness measurements.

As an alternative to using light source 50 as a light source (emitting light 45) and an ambient light sensor (detecting light 44) at different times, light source 50 may be an LED that is segmented into different portions that operate as a dedicated light source and as a dedicated ambient light sensor. In other words, the portion of light source 50 that forms the light source may emit light 45 while the portion of light source 50 that forms the ambient light sensor may detect light 44. In this way, a single LED may be operated as both a light source and an ambient light sensor, and may be used according to the timing diagram of FIG. 7 (or other suitable timing).

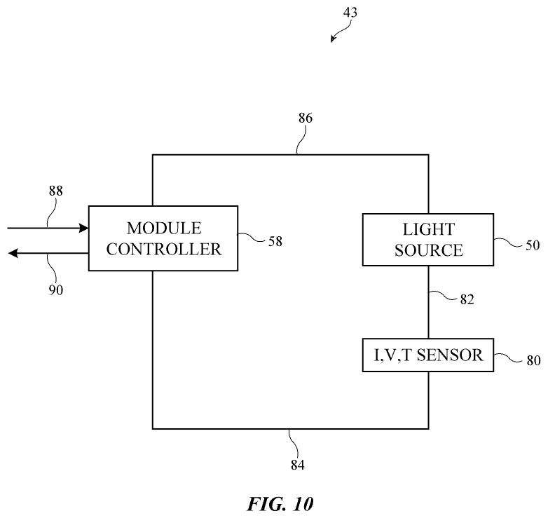

As discussed, an ambient light sensor (e.g., ambient light sensor 52) may monitor the output of a light source (e.g., light source 50) to verify that the light source is on. However, this is merely illustrative. In general, the status of the light source may be verified in any suitable manner. For example, the light source drive current, voltage, and/or temperature may be monitored to verify that the light source is on. An illustrative example is shown in FIG. 10.

As shown in FIG. 10, indicator light module 43 includes module controller 58 coupled to light source 50 over line 86. Light source 50 may be coupled to a current, voltage, and/or temperature sensor (I, V, T sensor 80) over line 82. I, V, T sensor 80 may in turn be coupled to module controller 58. For example, I, V, T sensor 80 may include a current sensing resistor with a corresponding analog-to-digital converter circuit (or other current sensor), a contact voltage sensor or other suitable voltage sensor, and/or a thermocouple or other suitable temperature sensor. Module controller 58 may receive signals 88, such as from control circuitry (e.g., control circuitry 16 of FIG. 1) and/or send signals 90, such as to the control circuitry.

In operation, module controller 58 may control light source 50 based on received signals 88. For example, module controller 58 may turn light source 50 on and off, and/or adjust the brightness of light source 50 based on received signals 88. Module controller 58 may receive measurements of the current, voltage, and/or temperature from I, V, T sensor 80. These measurements may verify whether light source 50 is on (e.g., when module controller 58 has activated light source 50).

Module controller 58 may verify the operation of light source 50 (e.g., that light source 50 is emitting light when module controller 58 has activated light source 50) and/or module controller 58 may send the measurements from I, V, T sensor 80 to the control circuitry, and the control circuitry may verify the operation of light source 50. In this way, the operation of light source 50 may be verified.

Although I, V, T sensor 80 is shown in indicator light module 43 that receives control signals from control circuitry outside of indicator light module 43, this is merely illustrative. In some embodiments, a sensor that measures the current, voltage, and/or temperature of a light source, such as I, V, T sensor 80, may be incorporated into a self-contained indicator light module. For example, I, V, T sensor 80 may be incorporated into indicator light module 40 of FIG. 5 or indicator light module 41 of FIG. 9. In general, I, V, T sensor 80 may be incorporated into any desired indicator light module to verify the operation of a light source.

As described above, one aspect of the present technology is the gathering and use of information such as sensor information. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is merely illustrative and various modifications can be made to the described embodiments. The foregoing embodiments may be implemented individually or in any combination.

What is claimed is:

1. An indicator light module, comprising:
an ambient light sensor configured to measure an ambient light brightness; and
a light source configured to emit light, wherein a brightness of the light is configured to be adjusted based on the ambient light brightness.

2. The indicator light module of claim 1, further comprising:
a module controller coupled to the ambient light sensor and to the light source, wherein the module controller is configured to adjust the brightness of the light based on the ambient light brightness.

3. The indicator light module of claim 2, further comprising:
an oscillator coupled to the module controller, wherein the module controller is configured to control the ambient light sensor and the light source based on signals received from the oscillator.

4. The indicator light module of claim 3, wherein the ambient light sensor is configured to measure the ambient light brightness during first time periods in which the light source is off and is configured to measure the ambient light brightness and the brightness of the light during second time periods in which the light source is on.

5. The indicator light module of claim 4, wherein the light source comprises a light-emitting diode, and the ambient light sensor comprises a photodiode.

6. The indicator light module of claim 5, further comprising:
an application-specific integrated circuit (ASIC), wherein the light-emitting diode is mounted on the ASIC, and the photodiode is formed on a surface of the ASIC.

7. The indicator light module of claim 6, further comprising:
a printed circuit board substrate, wherein the ASIC is mounted on the printed circuit board substrate; and
a transparent cover layer that covers the light-emitting diode, the photodiode, the ASIC, and at least a portion of the printed circuit board substrate.

8. The indicator light module of claim 5, wherein the light-emitting diode is stacked on the photodiode.

9. The indicator light module of claim 1, wherein the ambient light sensor and the light source are formed from a common light-emitting diode (LED).

10. The indicator light module of claim 9, further comprising:
an LED driver coupled to the common LED, wherein the LED driver is configured to bias the common LED with a first voltage to emit the light and to bias the common LED with a second voltage that is opposite the first voltage to measure the ambient light brightness; and
a module controller coupled to the LED driver, wherein the module controller is configured to adjust the brightness of the light based on the ambient light brightness.

11. The indicator light module of claim 10, wherein the first voltage is a positive voltage and the second voltage is a negative voltage.

12. The indicator light module of claim 9, wherein the common light-emitting diode has a first portion that is configured to emit the light and a second portion that is configured to measure the ambient light brightness.

13. The indicator light module of claim 1, further comprising:
a sensor configured to measure a voltage of the light source; and
a module controller coupled to the light source and to the sensor.

14. The indicator light module of claim 13, wherein the sensor is further configured to measure a temperature of the light source or a drive current of the light source.

15. An electronic device, comprising:
a housing;
a camera in the housing;
a microphone in the housing;
control circuitry in the housing and configured to adjust the camera and the microphone; and
an indicator light module, wherein the indicator light module comprises a light source and an ambient light sensor, the light source is configured to emit light when the camera or the microphone is on, and the indicator light module does not receive signals from the control circuitry.

16. The electronic device of claim 15, wherein the indicator light module comprises a module controller that is configured to adjust a brightness of the light source based on measurements from the ambient light sensor.

17. The electronic device of claim 16, wherein the indicator light module comprises an application-specific integrated circuit (ASIC), and the light source and the ambient light sensor are coupled to the ASIC.

18. The electronic device of claim 17, wherein the indicator light module further comprises a sensor configured to measure a voltage of the light source.

19. An indicator light module, comprising:
a light-emitting diode configured to emit light;
an ambient light sensor configured to measure a brightness of ambient light; and
a module controller configured to adjust a brightness of the light emitted by the light-emitting diode based on the brightness of the ambient light.

20. The indicator light module of claim 19, wherein the ambient light sensor is configured to measure the brightness of the ambient light during a first time period in which the light-emitting diode is off and to measure the brightness of the ambient light and the brightness of the light emitted by the light-emitting diode when the light-emitting diode is on.
